(19) United States
(12) Patent Application Publication
(10) Pub. No.: US 2009/0234034 A1
(43) Pub. Date: Sep. 17, 2009

(54) Method and apparatus to recycle waste pet bottles

(76) Inventor: Milagros Blanco, Apopka, FL (US)

Correspondence Address: Milagros Blanco, 121 Valley Hills Drive, Bostic, NC, 28018, US

(21) Appl. No.: 12/077,034

(22) Filed: Mar. 17, 2008

(51) Int. Cl. C08J 11/04; B29C 35/00

(52) U.S. Cl. 521/48; 425/317

(57) ABSTRACT

The invention relates to a chemical apparatus that produces solid-state polymerization, with heat exchanger for reaction chamber or reactants located therein. The apparatus recycles waste PET bottles and produce high quality PET pellets essentially free of contamination. The apparatus comprises an insulated housing or frame to receive small amounts of empty single serve plastic water bottles, with a movable lid to allow insertion of the bottles. The bottles are heated to the melting point, and a slow velocity fan on top of the lid to distribute heat inside the reactor. The tray inside the lower housing has cavities to hold the bottles, and several oval shaped molds at a lower level to receive the melt by gravity. These molds allow stationary cooling of the melted polymer, where it solidifies forming robust crystallized pellets. The apparatus relates to a countertop appliance intended for domestic use.

### CROSS-REFERENCE TO RELATED APPLICATIONS

| | | |
|---|---|---|
| Pat. # 4,064,112 | Dec. 20, 1977 | Rothe, Hans Joachim, et al, Process |
| | | for the continuous production of high |
| | | molecular weight polyethylene |
| | | terephthalate. |
| Pat. # 4,279,579 | Jul. 21, 1981 | Froeschke, Reinhald, Extrusion |
| | | apparatus. |
| Pat. # 5,148,993 | Sep. 22, 1992 | Kashiwagi, Hidehiro, Method for |
| | | recycling. treatment of refuse of |
| | | plastic molded articles and apparatus |
| | | therefore. |
| Pat. # 5,145,742 | Sep. 8, 1992 | Yau, Cheuk, Polymer pellet config- |
| | | uration for solid state polymerization. |
| Pat. # 5,340,509 | Aug. 23, 1994 | Chang, et al, Process for pelletizing |
| | | ultra high melt flow crystalline poly- |
| | | mers and product therefrom. |
| Pat. # 6,201,217 | Mar. 13, 2001 | Moon, et al, Counter top electric |
| | | cooker. Heating element and incoloy |
| | | material coated with ceramic coating |
| | | to provide radiation in the infrared |
| | | range to heat contents. |
| Pat. # 6,568,550 | Aug. 13, 2001 | Takiguchi; Kazuyuki, Plastic Con- |
| | | tainer and method for producing the |
| | | same. |
| Pat. # 7,132,632 | Feb. 25, 2004 | Huang, Jung-Tang, High frequency |
| | | induction heater built in an injection |
| | | mold. |
| Pat. # 7,066,084 | Jun. 27, 2006 | Simon Lajos, Devise for reducing |
| | | volume of bottle made of plastic |
| | | material. |
| Pat. # 7,022,751 | Apr. 4, 2006 | Zhang et al., Composite plastic |
| | | materials produced from waste |
| | | materials and methods of producing |
| | | the same. |
| Pat. # 7,021,203 | Apr. 4, 2006 | Beckeis, Alan L., Popeii Ron, Vented |
| | | Countertop Rotisserie oven. |
| Pat. # 7,157,032 | Jan. 2, 2007 | Eloo, Michael, Method and apparatus |
| | | for making crystalline PET pellets. |
| Pat. # 7,229,581, | Jun. 12, 2007 | Kern, et al., Process for producing |
| | | a thermoplastic film using plastic |
| | | bottle recyclate. |
| Pat. # 7,339,137 | Mar. 4, 2008 | Sorenson, Wally B., Sorenson, |
| | | Adam, Electric grilling appliance. |
| Pat. # 7,462,649 | Dec. 9, 2008 | Takuo Nakao et al., Method for re- |
| | | cycling PET bottles. |

### SEQUENCE LISTING

Not Applicable

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY REFERENCE OF MATERIAL SUBMITTED ON A COMPACT DISK

Not Applicable.

### BACKGROUND OF THE INVENTION

1. Field of Invention

The disposal of plastic water bottles, which are generated in very large quantities, is presently a large social and economic issue because of its bulkiness and the environmental degradation caused by the extremely long decomposition period of plastic.

PET products are excellent candidates for thermal recycling, its byproducts are versatile and highly marketable. Plastic manufacturers do not wish to invest substantial resources in new capital equipment to produce new PET polymer material. Existing recycling facilities have insufficient capacity to process the huge amounts of waste generated. The resulting demand for recycled PET material is three times over the existing supply. High availability of lower priced recycled PET is a significant economic consideration in the overall pricing of the finished product.

The present invention relates to a chemical apparatus with a heat exchanger for reaction chamber or reactants located therein to recover small amounts of polyethylene terephthalate (hereafter abbreviated as PET) waste water bottles and other PET material.

2. Description of the Related Art

The process to recycle plastic bottles at high volume industrial facilities include multiple steps as follows: mixed municipal solid wastes (MSW) including recyclable plastics (1) are collected from curbside recycling bins or drop-off sites, (2) sorted first by type of waste then by type of plastic at a material recovery facility either mechanically or manually; the plastic is (3) baled and (4) sent to a reclaimer where they are (5) cleaned, (6) ground into small flakes, (7) washed again, (8) dried, (9) melted, (10) filtered, and finally (11) made into pellets. The pellets are shipped to product manufacturing plants, where new plastic products are made. During sorting foreign material is not totally avoided resulting in mixed bales. Foreign materials still present in the waste generate various decomposition gases and decomposition materials during the heating and/or reaction process, resulting in the contamination and/or deterioration of the recovered product. These materials often solidifies in the recovering apparatuses causing damage to machinery and tools. Yield losses of about about 18% are reported.

In a similar fashion to other inventions “pellet” may be defined as any discrete unit or portion of a given material, having any shape or configuration, whether regular or irregular. The term “pellet” may include particles, droplets, pieces or portions of a given material.

The process of formation of PET pellets from viscous material is well known. Uniform crystallization of the polymer is important for further applications where mechanical and dimensional stability are also important. Thus, besides recycling waste PET bottles, invention objectives are (1) to produce relative uniform polymerization within each pellet with (2) robust crystalline morphology, and (3) substantially free of contamination materials. Pellets should be able to withstand the high temperatures of solid-state polymerization used to increase chain length without agglomerating, and without going through a lengthy and expensive annealing step to further produce high molecular weight material.

According to Rothe, Hans Joachim in U.S. Pat. No. 4,064,112, crystallization of the polymer needs less than 25% of the total reaction temperature required. Crystallization begins before the melting point is reached. Temperatures between 230° C. to 245° C. result in optimum reaction rate and lowest degree possible of thermal degradation. Crystallization time is about ½ hour.

According to Eloo, in U.S. Pat. No. 7,157,032 end users of PET polymer typically require the pellets to be in a crystalline state, rather than an amorphous state. Manufacturers of PET pellets must typically change the amorphous structure of the material to the crystalline structure, a very expensive step.

As Stouffer states in U.S. Pat. No. 5,744,074, forming robust, uniform pellets of polyester material has been difficult or problematic. For example, low molecular weight polyesters, characterized as oligomers or pre polymers, may have such a low viscosity that initial particle formation may be difficult. The oligomer may be too liquid to form particles or pellets of uniform size and shape. This is because oligomers, having relative short chain length, may have a relatively low amount of chain entanglement, in addition to limited intermolecular bonding forces. Known processes for forming polyester pellets may result in particles or droplets which lack structural integrity. The weakness of such particles make them hard to handle and susceptible to abrasion during transport or other mechanical handling. Abrasion may generate an undesirable amount of fines (dust).

Another problem associated in melting PET is flow blockage. During tests made using extrusion equipment by the Chelsea Center for Recycling and Economic Development, (Technical Report #38, August 2001), if the melt was cold enough to be in the viscosity range to pelletize it, it would solidify, freeze off, and cause a total flow blockage. The temperature and/or viscosity window was only a couple of degrees and far too narrow to control on a routine process basis. With the slightest temperature increase, the material acquired a water-like viscosity which is far too low to pelletize using an extrusion process. The stationary crystallization tray of the present invention solves problems associated with low viscosity and formation of robust, uniform crystallization pellets.

Several patents referenced below disclose melting plastic raw material and the formation of pastilles which are subsequently solidified and collected in processes that require several apparatuses and two or more steps. The result are crystalline pellets that may lack structural integrity, are prone to abrasion during handling and may generate an undesirable amount of fines. For example, Stouffer, Blanchard and Leffew, in U.S. Pat. No. 5,744,074, discloses an apparatus for producing low molecular weight polymer particles or pellets. The referenced apparatus use an outside reactor to transfers polymer melt by means of a pressure displacing devise into a rotating pellet former with a plurality of outlets for metering a polymer melt onto the surface of a conveyor. The conveyor is adapted with temperature controls to move the pellets through a crystallization section that extends from the point at which the pellets are received, to at least a downstream portion of the conveyor for a predetermined period of time.

Chang, et al., in U.S. Pat. No. 5,340,509 discloses a complex equipment and process for pelletizing ultra high melt flow crystalline polymer. In this patent, polymer melt is transferred to rotating outer and inner containers that allow uniform amounts of melt to drop upon a conveyor, where the droplets are cooled.

Froeschke, in U.S. Pat. No. 4,279,579 discloses an apparatus for the extrusion of a flow able mass through a rotating container onto a conveyor belt to form pastilles.

Eloo, in U.S. Pat. No. 7,157,032 discloses a method and complex apparatus for underwater pelletizing, that uses a centrifuge dryer, and transportation piping in between.

Kashiwagi, Hidehiro, in U.S. Pat. No. 5,148,993, discloses a a very complex apparatus to recycle refuse plastic molded articles comprised of a hot water immersion tank, an agitator, a steam injector, another piece of equipment to break plastic articles into fragments, blowers to sort the mixture by wind-force, further separating the fragments of plastic articles and residual labels by air stream sorting; ultrasonic cleaners to remove impurities, and finally equipment to prepare the purified plastic articles as chip or pellet plastic material.

U.S. Pat. No. 6,201,217 by Moon, et al, describes an apparatus where the metallic heating chamber is supported by a plastic base. A problem associated with the described construction is that the metallic plate can transfer too much heat from the heating unit to damage the housing components contacting the heating chamber, or can transfer too much heat surrounding the housing to a point where a user cannot comfortably touch the housing. Another problem associated with this construction is that pellets can be very difficult to remove the from the base, especially when the mold is hot.

In U.S. Pat. No. 7,066,084, Simon Lajos, describes several known plastic bottle compactors used together with heating. Several of these patents obtain volume reduction through a combination of compression and heating but result in an aggregate requiring further processing. Irregular compacting is especially obvious in some cases, optimal compression cannot be achieved, and the energy consumption increases significantly. The processes are complex and expensive.

The preferred embodiment of this invention to recycle PET bottles is very simple. Referenced patents require several steps, complex apparatuses including extruders, conveyor belts, compactors, water tanks, air injectors, or complex machinery setup, and/or chemical methods.

### BRIEF SUMMARY OF THE INVENTION

Besides recycling small quantities of clear PET material, the apparatus of this invention solves problems associated with the production of plastic pellets including: (a) the very narrow melting temperature window and (b) low viscosity of the plastic melt that may result in clogging when using extruders, (c) pellets lacking robust constitution, and/or (d) pellet agglomeration.

The apparatus is of simple construction and operation. During a single heat cycle the single apparatus will recycle waste material, produce crystalline PET pellets, and obtain optimal volume reduction.

Activation of the heating elements increases the reaction chamber temperature to slightly above the PET melting temperature of 260° C. (500° F.) in a controlled manner during a preset period of time, and not to exceed 280° C. (535° F.) to prevent overheating and material degradation. The heat application melts and crystallizes the plastic material.

Widespread use of the proposed apparatus will increase PET recovery rates, decrease environmental degradation and use of petroleum to make new material. To some extent, widespread use of the apparatus will shift traditional plastic bottles recycling from an industrial operation handling large quantities of domestic waste by solid waste management agencies to a household operation processing small amounts at the source of waste.

### BRIEF DESCRIPTION OF THE SEVERAL VIEWS OF THE DRAWINGS

FIG. 1 is a schematic illustration of a chemical apparatus with heat exchanger for reaction chamber, an interior tray to hold the bottles with a stationary crystallization area in the form of molds, and providing air circulation from the top of the lid in accordance with the present invention.

FIG. 2 illustrates certain components of the melting chamber lower section tray, arrangement of the receiving/crystallization molds at the base, and heating element location.

FIG. 3 is deleted (schematic diagram of the operating and control circuits). Circuits to perform the mentioned functions are well known and thus are not described.

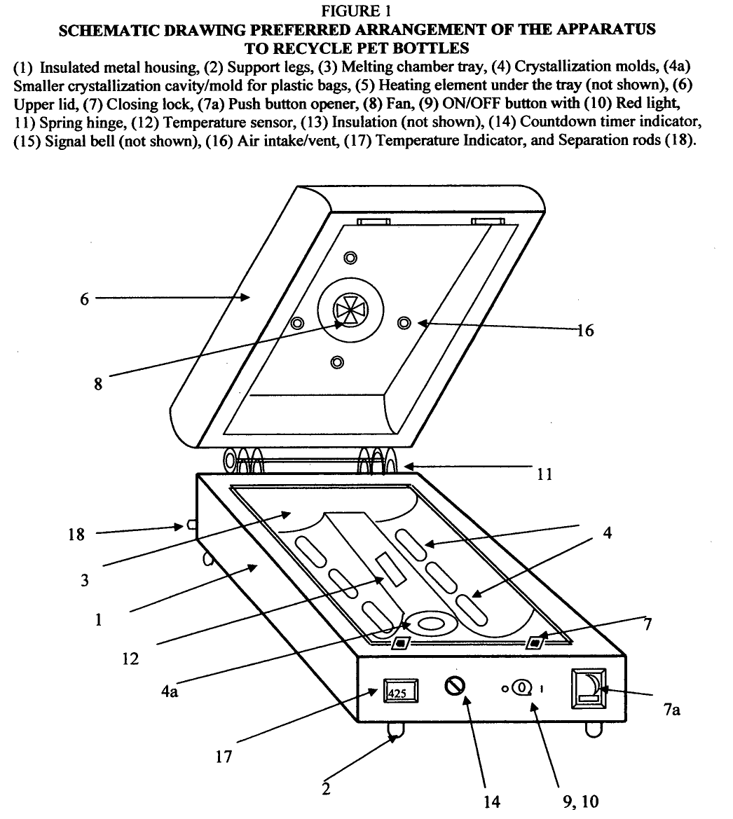

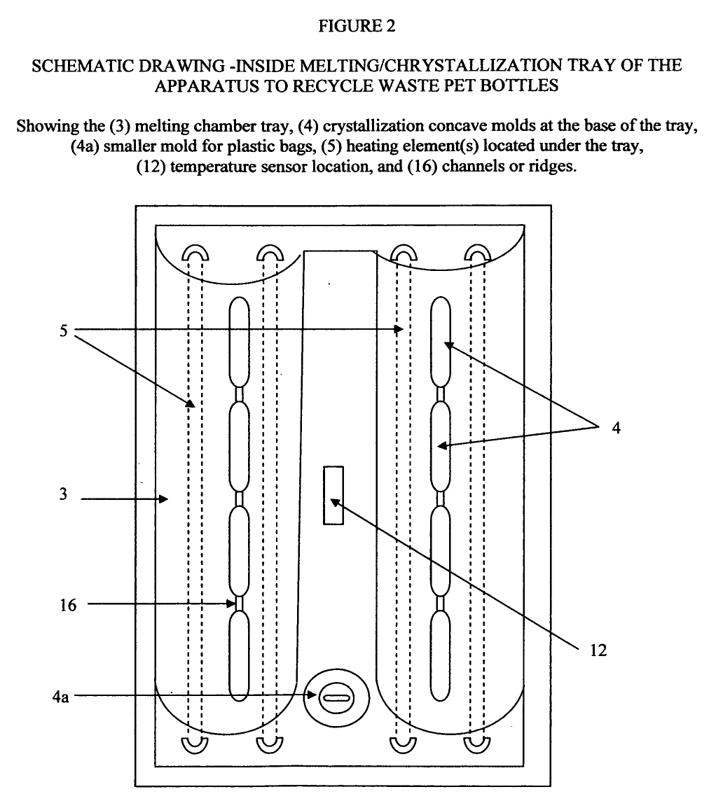

### DETAILED DESCRIPTION OF THE INVENTION

(Numbers in parenthesis refer to drawings)

Although the preferred embodiment of the invention is explained in detail, it is to be understood that the invention is not limited in its scope to the details of construction and arrangement of components set forth in the following description or illustrated in the drawings. The invention is capable of other embodiments and of being practiced or operated in various ways. Also, in describing the preferred embodiment, terminology will be resorted to for the sake of clarity. It is intended that each term contemplates its broader meaning as understood by those skilled in the art, and includes all technical equivalents which operate in a similar manner to accomplish a similar purpose.

The preferred embodiment comprises a reusable thermally insulated metal housing (1), having an upper and lower hollow body, with four legs for support (2), a melting chamber or chemical reactor configured with a removable tray (3) to hold bottles, having concave molds at a lower level (4), and a separate mold/cavity to place smaller objects (4a), electric heating elements (5) located under the tray, an upper manually opened lid (6) with closing lock (7), having a push button opener (7a), an electric slow speed fan (8) on top of the lid, a starting ON/OFF mechanism (9), with an imbedded red warning light in the front (10), the top lid mounted on a spring hinge (11), a temperature sensor and controller (12), insulation (13), countdown timer (14), signal bell (15), air intake/vent openings (16), temperature indicator (17) at the front of the housing, and exterior separating rods (18) at the back lower housing.

In the present invention, flow control of the melted plastic is not required.

Different from other referenced apparatuses, the crystallization area is stationary.

### PREFERRED EMBODIMENT SPECIFICATIONS

It is to be noted that the invention description refers to the specific amount and sizes of bottles to be processed. The invention is capable of other embodiments and being practiced and carried out in various ways. It is to be understood that the invention is not limited in its application to the details of construction and the arrangement of the components set forth in the following description or illustration in the drawings. The wording and terminology used herein should not be construed as limiting.

The preferred embodiment may be constructed with other configurations to accept larger sizes and amounts of bottles during a single operating cycle. Larger processing capacity may be obtained by placing several trays, one above the other in a tower fashion, and each tray heated by a separate set of heating elements. However, a two bottles capacity is advantageous to meet the needs of smaller families and people who live alone. The small size of the equipment makes efficient use of valuable counter space, an important feature when space is at a premium. The apparatus may be operated more frequently, as the entire cycle takes about half hour.

The insulated metal housing (1) is rectangular shaped, with an interior heating area having metal inside walls. The housing is secured or attached to four short legs (2) at the underside to provide safe structural support and prevent excessive heat from reaching the counter top. Two short separation rods (18) about 1¼ inch long positioned in the lower back side prevent the housing from touching the wall and provide air space. The legs and rods are secured by screws. Controls located at the front lower housing are accessible and facilitate viewing.

The housing has an also thermally insulated top lid (6) comprising of a domed top wall and two pairs of side walls mounted on spring hinges (11) at the back side. The lid is selectively manually movable between an open and closed position, opening by pressing a (7a) button on front. The upper lid (6) restricts access to the heating chamber (1) when closed and provides easy access when opened. When the lid swings upward, it is well within the clearance allowed by top mounted cabinets. The top lid interior is not coated with non stick material.

A small fan (8) on top of the lid, together with several small air intake holes (16) located around the fan allow passage of a limited quantity of air into the heating chamber. The air intakes (16) are framed by a metal tube that extends from the outer wall through the insulation to the heating chamber interior. The diameter of each vent is about ¼ inch. A narrow 1/16 inch side gap, between the upper lid and lower housing allows limited air venting to the outside.

The metal tray (3) hang without securing from the heating chamber side walls and prevent melted material from falling onto the heating elements located directly below the tray. The preferred embodiment tray (3) incorporates two semi-cylindrical cavities sized to accept inside each a single-serve size bottle ranging from 9 to 12 ounces, and no more than 9 inches tall and 2¾ inches wide. The tray may feature one additional small semicircular concave depression (4a) with a pellet-shaped mold at the bottom to hold other small plastic material. The cylindrical side walls of each bottle holding cavities slope downward from the perimeter wall towards the center, and blend into the receiving mold(s) (4) located at the tray lower level. The height of the receiving cavity is about one half of the bottles' height when laying horizontally. A dividing wall between the bottle holding cavities allows space for the heating elements (5) directly underneath.

Direct contact of the lower tray walls to parts of a specific bottle do not occur at all times, because different brands of plastic bottles may have different shapes or configurations, and bottles shrink during heating reducing the contact surface. The upper part of the bottles is heated mainly by radiation and hot air circulation. The upper heating chamber, or lid does not make direct contact with bottles.

The path of molten material into the lower receiving mold is not accessible during operation. Once the lid is locked, the operator is unable to intervene or touch hot material. The top lid remains closed until the cooling period ends and the housing reaches safe temperatures.

The stationary concave molds (4) at the lower section of the interior tray receive melted plastic by gravity. Channels or ridges (16) between individual pellet-shaped molds allow distribution of melted plastic. The ridges are half as deep as the molds.

The molds allow formation of pellets in a general oval shape, having a length of about 3 cm. and a width of 0.6 cm., the corners thereof forming lobes which protrude from the generally rectangular central section. The polymer pellet configuration has less tendency to stick during processing with heat.

The heating chamber, includes a temperature sensor (12), and a control devise (not shown in the figures) to provide precise predictive heating. A thermal circuitry shuts off the power supply if the heating area temperature reaches 280° C. The timer (14) control disconnects power to heating elements after a preset period.

A set of electric powered heating elements (5) are positioned within the heating chamber, one adjacent to each side wall, and two under each side of the central dividing wall between the bottles. The temperature sensor (12) is located in the center wall of the tray.

The simplified construction exclude heating elements at the upper lid because they would be less efficient as heat tends to rise. The small low speed electric fan (8) speeds the heat transfer in a similar manner as convection ovens, distributing heat over the bottle surface.

The heating elements receive electrical power from a conventional electrical supply system with a standard outlet connector, typically rated at 120 volts. A power cord contact block mechanically anchors the cable to the housing “ON/OFF” switch (9) with a lighted red indicator for the ON position. The heating element(s) remain active until the melt temperature range is reached.

The thermal insulation (13) (not shown in the schematic drawing) surround the interior of the reactor chamber top and bottom sections, isolate and protect the operator from heated surfaces. It minimize the risk of heating electrical components to a point where the components can be damaged, or where a user cannot comfortably handle the housings during or soon after ending the operation. Hot surfaces are not exposed during operation and outside housing temperatures are relatively cool to the touch allowing the appliance to be used in enclosed spaces.

The removable tray is composed of die-cast aluminum coated with a nonstick material such as that used in frying pans, or other suitable material to prevent sticking and allow easy removal of the pellets.

The apparatus features a serie of safety controls and shutdowns to interrupt the electrical power in case a potentially hazardous situation arise, consisting of:
Micro sensor to detect when door is in open position.
Control switch to disconnect the electrical power from the heating element when the door is open
Optional interlock device to prevent opening the door when heating rods are energized.
A pressure locking mechanism to prevent access when the heating element is activated.
Thermostatic switch to sense and control temperature. The bimetal switch setting disconnects at a preset temperature of 280° C. to prevent overheating.
Switches wired in serie must be simultaneously at the “ON” position for the heater element to be powered.
Red light (10) secured within the ON/OFF switch at the front of the housing to glow for visual warning during operation. The OFF red light indicates the heat element is disconnected and not receiving electric power.
The mechanical countdown timer, together with the bell sound to indicate when to safely open the lid. It can be substituted by an electronic digital timer to perform the same function.
Circuits to perform all the above mentioned functions are well known and thus are not herein described.

The temperature controller providing power to the fan motor (8) during the heating cycle may be configured to terminate power to the heating elements (5), while providing power to the fan motor (8) during the cooling stage.

### Operation:

Before insertion of bottles in the apparatus, the operator must manually remove all labels and cap, and drain any remaining water. Clear soda bottles must be rinsed clean. Other clean plastic materials such as sandwich bags or film must be twisted into the shape of a small ball, and placed into the designated small cavity. The top lid of the apparatus is manually opened, bottles inserted, and the lid closed firmly to engage the clamps. The large front opening makes it easy to load an unload. Upon activation of the ON/OFF switch, the red warning light will turn ON. The heating element is activated until reaching the preset temperature. The red warning light automatically turns OFF at the end of the preset temperature/time period. A single signal bell (15) sound indicates the end of the melt stage, and two bell sounds indicate the end of the cooling period. Once cooled to room temperature, the housing may be accessed by opening the top lid.

Bottles with a melting point above the preset temperature range will not melt. The apparatus will shut down after the allowed time period regardless if the loaded product has melted or not. Unmelted or partially melted material must be removed prior next use.

Pellets must be removed after each operation cycle to prevent overflow and agglomeration. The receiving tray is removable and coated with a nonstick material to make cleaning easy. Removed pellets can be stored in a closed container such as a zip-lock plastic bag or covered jar until sufficient amounts are collected to be redeemed for their value.

It should be understood that many features of the invention may find utility in other types of countertop electric appliances. Accordingly, no limitations are intended except insofar as expressly stated. Those skilled in the art will notice that the proposed operating concept may be readily used as the basis to design other structures, methods and systems for carrying out the several purposes of this invention. Therefore it is important that the claims made herein as regarded as including such equivalents, constructed insofar that they do not depart from the spirit and scope of the present invention.

1. Apparatus to recycle empty polyethylene terephthalate (PET) bottles and to produce solid-state polymerization within a heated reactor, and said apparatus comprising a housing or frame with a holding tray to receive bottles in a horizontal position, molds at the base of the tray, heating elements, temperature sensor, temperature control switches, timer, signal bell; and a fan at the top of the lid as the only moving part.

2. Apparatus described in claim 1, wherein the top surface of the bottle holding tray inside the lower section of the heating chamber is coated with non stick material, and said tray features several contiguous concave molds arranged on a lengthwise fashion at the base of each larger cavity where bottles are placed, whereas these molds are connected between them by narrow ridges half as deep as the molds to allow even distribution of the polymer melt.

3. The tray according to claim 2 wherein the individual molds or cavities located at the base of the tray are stationary, and pellets herein formed are retained during sufficient time to crystallize, while maintaining internal heat from the heating and subsequent melting of the material being recycled, until cooled and solidified, and in absence of any secondary heating step while remaining inside said molds producing a more complete and uniform crystallization of the polymer.

4. Apparatus according to claim 3, where the stationary crystallization molds at the base of the tray produce pellets of predetermined oval shape, having a length of about 3 cm. and a width of 0.6 cm; and pellets produced herein have robust constitution, and a crystallinity range greater than 15%.

5. Apparatus according to claim 1, wherein the heating elements are located under and adjacent to the section of the tray that hold bottles, and located farther from the crystallization area (molds); and said heating elements subject the bottles to controlled temperatures slightly above 260° C. (500° F.) and under 280° C. (535° F.).

6. The apparatus described in claim 1 wherein empty clear PET plastic bottles are melted, resulting in optimal volume reduction without the use of compression (e.g., about 10% to 15% of the original size).

7. Apparatus described in claim 1 wherein PET pellets produced are essentially free of contamination with the exception of very small amounts of residual glue from the removed labels.
